(19) United States
(12) Patent Application Publication
(10) Pub. No.: US 2004/0259448 A1
(43) Pub. Date: Dec. 23, 2004

(54) Textile laminates

(76) Inventors: Alan Michael Nahmias, Wakefield, RI (US); Jack Waksman, South Easton, MA (US)

Correspondence Address: FISH & RICHARDSON PC, 225 FRANKLIN ST, BOSTON, MA, 02110, US

(21) Appl. No.: 10/465,021

(22) Filed: Jun. 19, 2003

(51) Int. Cl. B32B 7/12

(52) U.S. Cl. 442/149; 442/150; 428/354

(57) ABSTRACT

The invention features a textile laminate including a textile layer, a barrier layer, and an adhesive for bonding the laminate to the substrate. Preferred adhesives provide a combination of low temperature tack and high temperature performance. The low temperature tack allows the laminate to be adhered to the substrate at a temperature significantly lower than the melting point of the barrier film, while the high temperature performance allows the laminate to survive extended high temperature aging.

### TECHNICAL FIELD

This invention relates to textile laminates.

### BACKGROUND

Textile laminates are used in the automotive industry, for example as the decorative fabric on door panels of cars and trucks. Some of these laminates include a textile, such as fabric or carpet (e.g., for the lower area of the door panel), and an adhesive that adheres the laminate to a substrate such as a door panel. In some cases, the laminate also includes a barrier layer to prevent the adhesive from migrating into the textile. A fabric laminate including a barrier layer is described in U.S. Pat. No. 5,874,140. Fabric laminates are also used in other automotive applications, for example as head liners, foam-in-place seat cushion covers, elbow padding “bolster” trim panels and kick panels on door panels, seat backs, pillar covers, load floors, package trays and the like.

### SUMMARY

The invention features a textile laminate including a textile layer, a barrier layer, and an adhesive for bonding the laminate to the substrate. Preferred adhesives provide a combination of low temperature tack and high temperature performance. The low temperature tack allows the laminate to be adhered to the substrate at a temperature significantly lower than the melting point of the barrier film, while the high temperature performance allows the laminate to survive extended high temperature aging, e.g., up to 4 days at temperatures ranging from −40 to 237° F. 40 to 114° C.), without delamination. Some preferred laminates pass General Motors' high temperature aging specifications such as GM 9452P and GM 9505P “M”.

Suitable adhesives include urethanes. In some implementations, the barrier film includes an olefin polymer that has been modified for greater polarity, for example, by surface treating (e.g., by corona, flame or plasma treatment), or by incorporating functional groups into the polymer that increase polarity, e.g., acrylic acid groups. Other suitable barrier layers include urethane films. The laminate may also include a second adhesive layer that bonds the barrier layer to the fabric, e.g., a hot melt adhesive such as a reactive urethane.

In one aspect, the invention features a textile laminate in which the adhesive has a tack temperature of less than about 160° F. (71° C.), and the laminate has a sufficiently high melt bond strength to enable the laminate to remain adhered to a substrate to which the laminate had been bonded when the substrate is heated to a temperature of 100° F. or higher during subsequent processing. For example, some preferred adhesives have a melt bond strength of at least 1 Newton/25 mm at 80° C. (170° F.).

In another aspect, the invention features a textile laminate in which the adhesive includes a blocked-isocyanate polyurethane.

In a third aspect, the invention features a textile laminate in which the barrier layer includes an olefinic polymer and has a surface polarity of at least 36 dynes.

Some implementations include one or more of the following features. The adhesive has a DSC melting point between 120 and 140° F. (49 and 60° C.). The adhesive includes a substantially continuous film. The barrier film includes an acid-modified olefin polymer. The barrier film has been surface-treated to increase its surface polarity. The barrier film includes a urethane. The laminate further includes a laminating adhesive disposed between the textile layer and the barrier layer. The laminating adhesive is discontinuous. The laminating adhesive includes a urethane. The urethane includes a reactive hot-melt urethane. The laminating adhesive includes an olefin having a surface polarity of at least 36 dynes. The laminating adhesive includes an acid-modified olefin. The textile includes a material selected from the group consisting of woven and nonwoven fabrics, sheet-form foam materials, carpeting, and synthetic and simulated textiles. The textile includes a material selected from the group consisting of plastic films and sheet materials formed of PVC, thermoplastic urethanes (TPU), thermoplastic olefins (TPO) or blends thereof.

In some implementations, a barrier layer is not needed. Thus, in other aspects the invention features the textile laminates described above, with the barrier layer omitted, so that the adhesive is disposed directly on a surface of the textile layer, or replaced by an intermediate layer that provides properties other than barrier properties.

The invention also features methods of applying the textile laminate to various substrates. For example, the invention features methods of forming interior panels of vehicles, including adhering, to a first surface of a panel preform, one of the textile laminates discussed above, placing the panel preform and textile laminate in a mold, and applying a molding material to a second surface of the panel preform to form a finished interior panel.

The adhering step may include applying the laminate to the panel preform while the panel preform is still above ambient temperature as a result of molding. The adhering step may include thermoforming. The applying step may include heating to a temperature of at least 150° F. (66° C.).

In a further aspect, the invention features methods of forming the textile laminates described above. For example, the invention features a method of forming a textile laminate including laminating a continuous film of urethane adhesive to a barrier layer to form a composite, and laminating the composite to a textile layer.

Some implementations may include one or more of the following features. The method further includes applying a discontinuous adhesive layer to the textile layer. The discontinuous adhesive layer is applied to the textile layer prior to laminating the composite to the textile layer. The discontinuous adhesive layer is applied to a surface of the textile layer opposite the surface to which the composite is laminated. The method further includes forming the continuous film of urethane adhesive by casting an adhesive solution on a release film.

The details of one or more embodiments of the invention are set forth in the accompanying drawings and the description below. Other features and advantages of the invention will be apparent from the description and drawings, and from the claims.

### DESCRIPTION OF DRAWINGS

FIGS. 1-4 are diagrammatic, highly enlarged cross-sectional views of textile laminates according to various implementations of the invention.

FIGS. 5 and 5A are diagrammatic views showing a process for making a textile laminate.

Like reference symbols in the various drawings indicate like elements.

### DETAILED DESCRIPTION

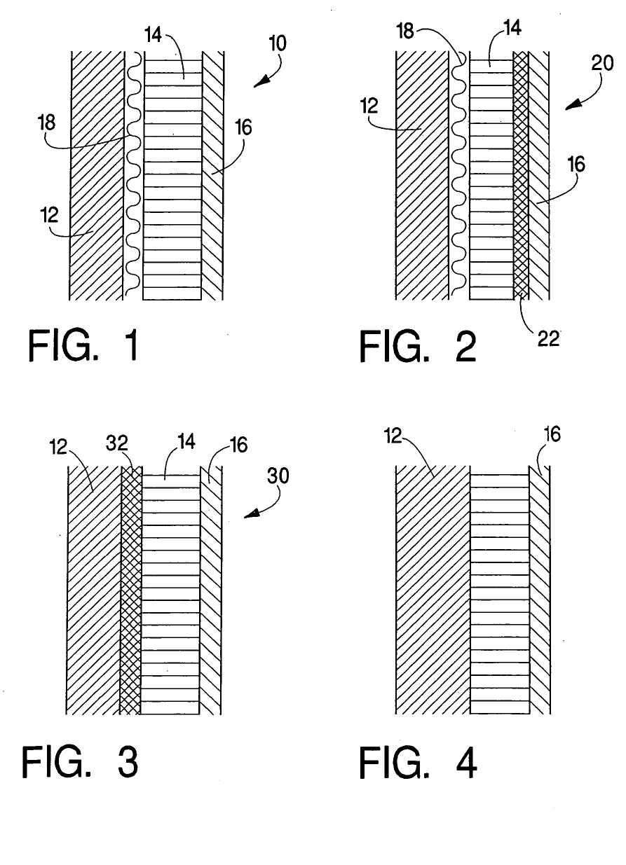

Referring to FIG. 1, a textile laminate 10 includes a preferred textile layer 12, a barrier layer 14 laminated, and an adhesive layer 16. The textile layer is laminated to one surface of the barrier layer by a laminating adhesive 18, and the adhesive layer 16 is applied to the other, exposed, surface of the barrier layer. The adhesive layer 16 is exposed for attachment to the surface of a door panel or other substrate (not shown). The textile layer will be exposed as a decorative layer after the laminate is adhered to the substrate. The barrier layer prevents migration of the adhesive layer 16 into the textile layer 12, and provides a vacuum barrier that facilitates manufacturing operations such as thermoforming.

As shown in FIG. 2, in an alternate textile laminate 20 a tie layer 22 may be provided between the barrier layer 14 and the adhesive layer 16. The tie layer 22 may be integral with the barrier layer, or may be a separate layer as shown. The tie layer 22 enhances the adhesion between the barrier layer 14 and the adhesive layer 16.

Alternatively, as shown in FIG. 3, in textile laminate 30 a tie layer 32 is provided between the textile layer 12 and the barrier layer 14. In this case, the laminating adhesive 18 may be omitted, if the tie layer 32 provides sufficient adhesion between the textile layer and barrier layer to allow successful lamination. If the barrier layer adheres sufficiently well to the textile layer, the barrier layer may be laminated directly to the textile layer without an intervening tie layer or laminating adhesive, as shown in FIG. 4.

Adhesive layer 16 may be any desired adhesive that will adhere to the substrate to which the textile laminate is to be attached. Preferred adhesives provide both a low tack temperature, e.g., less than 170° F. (77° C.) and typically less than about 155° F.-160° F. (68-71° C.), and a relatively high melt strength, e.g., sufficient melt strength to a bond strength of the textile laminate to the substrate to which the laminate is adhered of at least 3 Newtons/25 mm, preferably at least 6 Newtons/25 mm, at room temperature and at least 1 Newton/25 mm, preferably at least 2 Newtons/25 mm at 80° C. (176° F.), measured according to ASTM 751.

The tack temperature, i.e., the initial tack point, of the adhesive is preferably at least 30° F. (−1° C.) below the melting point of the barrier film that the adhesive is to be applied to, to prevent damage to the barrier film during manufacturing of the laminate. It is also generally preferred that the tack temperature be sufficiently low so as to allow the laminate to adhere well to a substrate, e.g., a door panel face, that is still warm from molding, e.g., at a temperature of about 120-140° F. F (49-60° C.). It is also preferred that the adhesive exhibit a sharply defined DSC melting point between 120F.-140° F. (49° C.-60° C.).

Suitable adhesives for use in forming the adhesive layer include reactive urethanes that have relatively low tack temperatures, as discussed above, and exhibit good performance characteristics, e.g., good bond strength at elevated temperatures, typically 200-250° F.(93-121° C.). Suitable urethanes include aliphatic urethane ether polymers. For example, the urethane may be a blend of a one pack blocked isocyanate and an anionic polyurethane dispersion, or may be a two pack hydroxyl terminated urethane oligomer and polyisocyanate. Suitable urethanes are generally water-borne. Suitable adhesives generally soften and bond to a barrier film at 160° F. (71.11° C.) or less, and bond permanently to a substrate at temperatures of 180° F. to 210° F. (82° C. to 99° C.). A suitable adhesive is CI-6215M2 Urethane Film Adhesive, manufactured by Coat-It, Inc., a division of Diversified Chemical Technologies, Inc., Detroit, Mich.

Advantageously, due to the presence of the barrier film, the generally high-cost adhesive layer can be relatively thin. For example, the adhesive layer may have a coating weight of less than 1.0 oz/yd, typically from about 0.4 to 1.0 oz/yd.

Suitable barrier films include olefin-based films that have been modified for greater polarity, for example, by surface treating (corona, flame or plasma treatment), or by incorporating functional groups into the olefin polymer to increase its polarity, e.g., acrylic acid groups. For example, about 1-20%, typically about 5-10%, polymerized acrylic acid groups may be added to the olefin polymer. Generally, the polarity of the modified polymer will be about 36 to 38 dynes. Suitable olefin polymers include, for example, polyethylene, ethylene-propylene copolymers, ethylene-propylene-butylene copolymers, propylene-butylene copolymers, polypropylene and polybutylene. Materials that may be blended with the olefin to provide acrylic acid groups include EMA, EAA, and ionomer. Other functional groups may also be used to increase the polarity of the olefin, e.g., maleic anhydride and acetate groups. Acetate groups may be provided, for example, by blending EVA with the olefin. The functional groups can be provided in the polymer backbone or can be terminal groups. The polymer providing functional groups can be mixed with or reacted with the olefin. These films may be multilayer or monolayer. In the case of multilayer films, the tie layer 22 or 32 discussed above may be included as one layer of the film. If desired, both surface treatment and functionality can be used to modify the polarity of the olefin. Suitable acrylic acid functional polymers are commercially available from, for example, Dow under the tradename PRIMACOR and from Dupont under the tradename NUCREL. Suitable maleic anhydride functional polymers are available from Atofina under the tradename LOTADER.

Other suitable barrier films include urethane-based films. These films are generally inherently polar and thus do not require modification to increase their polarity. Suitable urethane films include thermoplastic polyurethanes, for example aromatic polyether type thermoplastic polyurethane films and high molecular weight thermoplastic polyurethane monofilms. Such films are commercially available, for example from Omniflex, Greenfield, Mass. under the tradename VACUFLEX, and from Deerfield Urethane under the tradename DUREFLEX.

Suitable barrier films may be moisture vapor transmissive or non-moisture vapor transmissive. Suitable moisture vapor transmissive films may have a MVT of about 600 to 1500. The barrier film generally has a thickness of from about 0.5 to 3 mils, and a melting temperature of at least 200° F. (93° C.), e.g., about 200 to 300° F. (93 to 149° C.). If the laminate is to be used in an application involving subsequent high temperature molding and/or use conditions, the barrier film may have a significantly higher melting temperature, e.g., 300° F. (149° C.) or higher. Higher melting temperature films may tend to be more expensive, and thus the barrier film may be selected based on a balance between cost and required properties. Suitable barrier films generally have a sufficient impact resistance to resist tearing under pressures that the laminate is expected to encounter during subsequent manufacturing operations, e.g., pressures of up to 5 to 10 psi. In some implementations, the barrier film will have an ultimate tensile strength (ASTM D 882) of at least 20 N/mm², and an ultimate elongation (ASTM D 882) of at least 250%. If desired, the barrier film may include up to 100% regrind material.

The laminating adhesive 18 may be a hot-melt reactive urethane, e.g., a moisture cure urethane. Alternatively, the laminating adhesive may be a thermoplastic acrylic acid modified olefin polymer. In this case, the same polymers may be used that are described above for the barrier layer. To facilitate processing, the polymer used for the laminating adhesive will generally have a lower viscosity (e.g., 5,000 to 30,000 cps) or a higher melt flow index (e.g., 100 to 1500) than the polymer used for the barrier film. The laminating adhesive typically has a melting temperature in the range of 210F to 350F (99° C. to 177° C.). Suitable adhesives are commercially available from many companies such as Sovereign, National Starch, Forbo, ATOFina, DuPont, Dow, and others. Suitable urethane-type adhesives are described in U.S. Pat. No. 5,874,140, the disclosure of which is incorporated by reference.

Preferably, the laminating adhesive 18 is applied in a discontinuous pattern. Suitable methods for applying an adhesive in a discontinuous pattern are well-known, and are described, for example, in U.S. Pat. No. 5,874,140, incorporated by reference above.

The tie layer 22 or 32 may be any suitable material that will enhance adhesion. Suitable materials include relatively polar materials such as ethylene-methacrylic acid copolymers; ethylene-acrylic acid copolymers; ionomer copolymers; and corona, plasma, or flame treated olefins such as polyethylene, ethylene-propylene, and ethylene-propylene-butylene. As noted above, the tie layer 22 or 32 may be provided as an integral part of a multi-layer barrier film.

The term “textile,” as used herein, refers to any material that would be suitable for use in an exposed, trim layer of a part in a particular application. For example, in the automotive industry, such exposed trim surfaces are commonly referred to as the “A surface” of a part. Suitable textiles include woven and nonwoven fabrics, including upholstery materials and nylons and polyesters that are used in headliners, and other textile materials such as carpeting. Other suitable textiles include synthetic and simulated textiles, such as plastic films and sheet materials that are used to replace fabric in some applications. Materials used in simulated textiles include PVC, thermoplastic urethanes (TPU), and thermoplastic olefins (TPO). Other suitable materials for the textile layer include polymeric films such as PE, OPP, cast and blown PP, OPET, nylon and other polyamides, and PEN, and nonwovens, such as PE, PP, PET, polyamide, and copolymers, blends and multi-layer constructions thereof.

The barrier layer may be omitted, if barrier properties are not required in a particular application. In this case, the adhesive 16 may be applied directly to the textile layer. For example, the textile laminate may be comprised of a carpet or nonwoven textile layer and a layer of adhesive 16.

Alternatively, an intermediate layer may be provided between the adhesive 16 and the textile layer, to provide desired structural, aesthetic, or other properties. The intermediate layer may replace the barrier layer, or may be provided in addition to the barrier layer. Suitable intermediate layers include, for example, fabrics, such as nylons and polyesters that are used in headliners; foams, such as polyethylene (PE), polypropylene (PP), urethane ether, urethane ester and polystyrene; polymeric films, such as PE, OPP, cast and blown PP, OPET, nylon and other polyamides, and PEN; and nonwovens, such as PE, PP, PET, polyamide, and copolymers, blends and multi-layer constructions thereof. If desired, the textile layer and intermediate layer may be similar, e.g., may be two different types of nonwovens. In some applications, it may be desirable for the intermediate layer to include a foam, to provide conformability to the substrate and/or aesthetic properties. For example, a textile laminate suitable for use in a headliner may include a nylon or polyester knit tricot textile layer and an intermediate layer including a urethane foam. The intermediate layer may be adhered to the textile layer in any desired manner, including those discussed above for adhering the barrier layer to the textile layer.

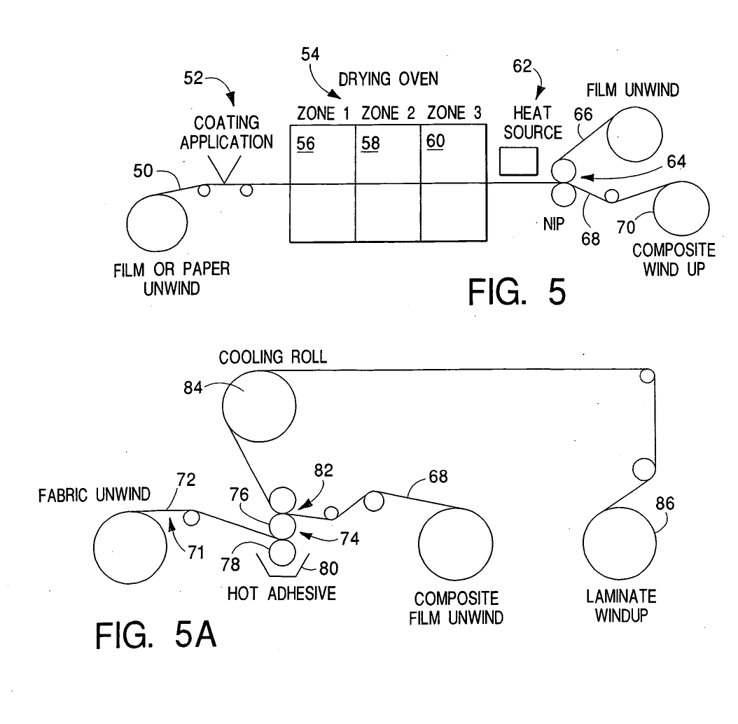

The textile laminates may be formed using any suitable process. In some implementations, the laminates are formed using the following process, which is shown diagrammatically in FIGS. 5 and 5A. The adhesive for adhesive layer 16 is provided in a solvent or water-based solution. The solids level of the solution coating may be adjusted to provide the optimum viscosity for the coating equipment being used, but is typically from about 40to 55%. This solution may be blended with a surfactant, such as cocoamine propyl oxide, to enhance wetting. Referring to FIG. 5, the adhesive solution is coated on a release paper 50 by a coating applicator 52 to form a continuous coating. The coated release paper may be inspected to ensure that the coating is substantially free of defects such as pinholes and fish-eyes. The release paper and adhesive coating then enter a zone oven 54, where the adhesive is dried at a sufficiently low temperature and rate so as to avoid bubbles or voids in the dried adhesive coating. Typically the drying temperatures are about 180-190° F. (82-88° C.) in the first zone 56, 220° F. (104° C.) in the second zone 58 and 230-250° F. (110-121° C.) in the third and final zone 60. The release paper and dried adhesive coating are passed under a heater 62, which raises the temperature of the dried coating to about 20° F. (−7° C.) above its initial tack temperature. The heated coating is then passed through a nip 64, with the barrier layer 66, to laminate the barrier layer to the adhesive coating forming a composite 68. The composite 68 can then be rolled up onto a take-up roll 70, as shown. The release paper can be left on the composite as an interleaving, or the paper can be removed and re-rolled for re-use in the future. The composite is then laminated to the textile layer, e.g., using the process shown in FIG. 5A, to form the final textile laminate. Referring to FIG. 5A, a back surface 71 of textile layer 72 is coated with a laminating adhesive by passing the composite through a nip 74 between a middle roll 76 and a coating roll 78. A portion of coating roll 78 is immersed in a bath 80 of the laminating adhesive. The laminating adhesive is in liquid form, e.g., is a molten hot melt material, and is taken up by the coating roll and applied to the textile layer in the nip. The coated textile layer then passes through an upper nip 82, where the composite 68 is introduced and adhered to the laminating adhesive. The resulting textile laminate is passed over a cooling roll 84, and wound up on a take up roll 86.

The two processes shown in FIGS. 5 and 5A may be combined into a single in-line process if desired. Moreover, if desired, the finished textile composite may be passed to further in-line processing, rather than taken up on take up roll 86.

To apply the textile laminate to a door panel, a die cut portion of the laminate is adhered, e.g., by thermoforming, onto a surface of the face of the door panel. The laminate may be applied to the surface while the face of the door panel is still warm from molding. Any other desired trim parts are then applied to the door panel face, the door panel face is placed in a mold, and molding compound is molded onto the door panel face to form the finished door panel. The textile laminate may be subjected to a wide variety of process conditions, which will vary depending on the particular process used by the automotive manufacturer. In general, these conditions may range from a low bonding time of 7 seconds at a temperature of 155 F (68.3° C.) to a high bonding time and temperature of 250 F (121.1° C.) for 120 seconds. The process may also include vacuum pressure, e.g., up to about 10 inches water. Post-processing steps may also require the laminate to withstand heat and/or pressure. For example, holes may be punched in the door panel to accommodate various parts such as a window crank, lock button or the like. These holes may be punched through the door panel and the adhered textile laminate while the panel is still warm from molding, e.g., at 100-155 F. The high melt bond strength of the preferred adhesives allows the textile laminate to stay in place during such rigorous post-processing operations.

The textile laminates described above may also be used in the manufacture of headliners for vehicles. Generally, the headliner forming process includes providing a headliner shell, which may be flat or preformed, heating the shell, forming it if it has not been preformed, and applying the textile laminate to the surface of the shell that will be exposed in the vehicle. The forming and applying steps may take place at the same time, or the shell may be formed prior to applying the textile laminate to its surface. The applying step may take place, for example, in a mold or in a press such as a marriage press. The shell is generally provided as a rigid sheet or preform, but in some cases may be provided in the form of a flexible sheet, e.g., a nonwoven or resin-impregnated woven or non-woven, that becomes rigid during or after the heating and forming steps.

Many other parts having a trim surface may be manufactured using similar molding and/or pressure laminating processes. Advantageously, due to the relatively low tack temperatures of the preferred adhesives, the textile laminates may often be adhered to surfaces that are warm from previous molding processes, without the need to apply additional heat to obtain initial adhesion.

The laminate may be adhered to a wide variety of substrates. Suitable substrates include ABS; GRS (glass reinforced urethane); greenwood; wood fiber (Masonite); rigid PVC; rigid urethane foams; nonwovens, e.g., polyester, polyamide or polypropylene, impregnated with curable resin; and thermoplastic olefins (TPO), for example glass-reinforced TPO or irradiated foamed TPO.

### EXAMPLE 1

A textile laminate was formed by the following process. A 2% solution of cocoamine propyl oxide was added to a water-borne urethane adhesive (CI-6215M2 Urethane Film Adhesive, manufactured by Coat-It, Inc.) having a viscosity of 7000-8000 cps.

The resulting mixture was knife over-gap coated onto a release sheet at 10 to 20 yards per minute, and dried in a zone oven at temperatures of 180, 220, and 250° F. (82.2, 104.4, and 121.1° C.) as discussed above. The urethane adhesive layer had a softening point, after drying, of 160° F. (71.1° C.), and a hardness of 90-96 Shore A.

An ether-based urethane barrier film with a hardness of 90-96 Shore A and a melt point of 330° F. (165.7° C.) was laminated to the dried adhesive layer at a nip pressure of 23 pounds per lineal inch (pli), after first softening the dried adhesive layer by heating it to about 180-200 F (82-93° C.). The barrier layer included 50% regrind for low cost.

A seating fabric known in the trade as body cloth (“Dorchester” (Collins & Aikman), 12 oz/yd²) was applied to the barrier/adhesive composite as described above with reference to FIG. 5A. The textile laminate exhibited bond strength in excess of the fabric resulting in fabric tear. In addition it passed automotive cycling tests (4 cycles from −30° C. to +85° C. (−22° F. to +185° F.), with 6 hours at each temperature). Passing required that, after cycling, the textile laminate exhibit no visible delamination and have a bond strength of at least 3 Newtons/25 mm at room temperature and at least 1 Newton/25 mm at 80° C. (176° F.).

### EXAMPLE 2

A barrier layer/adhesive composite was formed as described in Example 1, except that the ether-based urethane barrier film was replaced by a monolayer ethylene acrylic acid (EAA) olefin film with a melting point of 210° F. (98.89° C.) and an acrylic acid content of about 7%. A non woven polyester material known in the trade as carpet (“Temperance,” Foss, 9 oz/yd² was applied to the barrier/adhesive composite. The textile laminate exhibited bond strength in excess of the fibers of the nonwoven resulting in fiber tear. In addition the textile laminate passed the automotive cycling tests described in Example 1.

### EXAMPLE 3

A laminate was formed as described in Example 2, except that the film layer was a two-layer film consisting of a layer of polyethylene (PE) with a small amount of EAA blended in, and a layer of EAA, and the textile layer was a knit polyester material known in the trade as brushed tricot (“Alpine,” Guilford Mills, 2 oz/yd²). The laminate exhibited bond strength in excess of the fibers of the knit resulting in fiber tear. In addition it passed the automotive cycling tests described in Example 1.

### EXAMPLE 4

A laminate was formed as described in Example 2, except that the film layer was a two-layer film consisting of a layer of polyethylene (PE) with a small amount of EAA blended in, and a layer of EAA. A urethane foam material known in the trade as headliner foam was applied to the barrier/adhesive composite. The foam had a density of about 1.8 pounds per cubic foot. The laminate exhibited bond strength in excess of the strength of the foam resulting in foam tear. In addition it passed the automotive cycling tests described in Example 1.

### EXAMPLE 5

A laminate was formed as described in Example 2, except the urethane adhesive was replaced with a two-part water-based polyurethane including hydroxyl terminated urethane oligomers and polyisocyanate. The polyurethane was an aliphatic urethane ether polymer with a glass transition beginning at 120F (48.89° C.) and ending at 158F (70° C.). The adhesive softened and bonded to the barrier film at 160F, and its bond continued to develop as processing temperatures were raised to 200F (93.33° C.). The polyurethane adhesive contained a small amount of hydrozane to retard chain extension during storage and improve shelf life. The dried adhesive had a hardness of 85 to 95 Shore A.

The fully polymerized adhesive is composed of 33 mole percent Carbon, 9 mole percent Oxygen, 2 mole percent Nitrogen, and 55 mole percent Hydrogen (chemical formula C₃₃H₅₅N₂O₉). The results were the same as described in Example 2.

A number of embodiments of the invention have been described. Nevertheless, it will be understood that various modifications may be made without departing from the spirit and scope of the invention. For example, the polymers described above for the barrier film and laminating adhesive may be replaced by any acrylic acid modified polymer and/or any suitable urethane adhesive with the appropriate melting point Accordingly, other embodiments are within the scope of the following claims.

What is claimed is:

1. A textile laminate comprising:
a barrier layer;
a textile layer laminated to one surface of the barrier layer; and
an adhesive on an opposite surface of the barrier layer, the adhesive having a tack temperature of less than about 160° F. (71° C.),
the laminate having a sufficiently high melt bond strength to enable the laminate to remain adhered to a substrate to which the laminate had been bonded when the substrate is heated to a temperature of 100F or higher during subsequent processing.

2. A textile laminate comprising:
a barrier layer;
a textile layer laminated to one surface of the barrier layer; and
an adhesive, comprising a blocked-isocyanate polyurethane, on an opposite surface of the barrier layer.

3. A textile laminate comprising:
a barrier layer comprising an olefinic polymer and having a surface polarity of at least 36 dynes;
a textile layer laminated to one surface of the barrier layer; and
an adhesive on an opposite surface of the barrier layer.

4. The textile laminate of claim 1 wherein the adhesive has a melt bond strength of at least 1 Newton/25 mm at 80° C. (176° F.).

5. The textile laminate of claim 1, 2 or 3 wherein the laminate is able to survive up to 4 days at temperatures ranging from −40 to 237° F. (−40 to 114° C.) without delamination.

6. The textile laminate of claim 1, 2 or 3 wherein the adhesive has a DSC melting point between 120 and 140° F. (49 and 60° C.).

7. The textile laminate of claim 1, 2 or 3 wherein the adhesive comprises a substantially continuous film

8. The textile laminate of claim 1, 2 or 3 wherein the barrier film comprises an acid-modified olefin polymer.

9. The textile laminate of claim 1, 2 or 3 wherein the barrier film has been surface-treated to increase its surface polarity.

10. The textile laminate of claim 1 or 2 wherein the barrier film comprises a urethane.

11. The textile laminate of claim 1, 2 or 3 further comprising a laminating adhesive disposed between the textile layer and the barrier layer.

12. The textile laminate of claim 11 wherein the laminating adhesive is discontinuous.

13. The textile laminate of claim 11 wherein the laminating adhesive comprises a urethane.

14. The textile laminate of claim 13 wherein the urethane comprises a reactive hot-melt urethane.

15. The textile laminate of claim 11 wherein the laminating adhesive comprises an olefin having a surface polarity of at least 36 dynes.

16. The textile laminate of claim 15 wherein the laminating adhesive comprises an acid-modified olefin.

17. The textile laminate of claim 1, 2 or 3 wherein the textile comprises a material selected from the group consisting of fabrics, sheet-form foam materials, carpeting, nonwoven materials, and synthetic and simulated textiles.

18. The textile laminate of claim 17 wherein the textile comprises a material selected from the group consisting of plastic films and sheet materials formed of PVC, thermoplastic urethanes (TPU), thermoplastic olefins (TPO), PE, PP, urethane esters or ethers, polystyrene, OPP, OPET, PEN, polyamides, and blends thereof.

19. A textile laminate comprising:
a textile layer; and
an adhesive, adjacent a surface of the textile layer, the adhesive having a tack temperature of less than about 160° F. (71° C.),
the laminate having a sufficiently high melt bond strength to enable the laminate to remain adhered to a substrate to which the laminate had been bonded when the substrate is heated to a temperature of 100F or higher during subsequent processing.

20. A textile laminate comprising:
a textile layer; and
an adhesive, comprising a blocked-isocyanate polyurethane, adjacent a surface of the textile layer.

21. The textile laminate of claim 19 or 20, further comprising an intermediate material, interposed between the textile layer and the adhesive.

22. The textile laminate of claim 21 wherein the intermediate material is selected from the group consisting of fabrics, foams, polymeric films and nonwoven materials.

23. The textile laminate of claim 21, wherein the textile layer comprises a fabric and the intermediate layer comprises a foam.

24. The textile laminate of claim 21 wherein the textile layer and intermediate layer comprise different nonwoven materials.

25. The textile laminate of claim 19 or 20 wherein the adhesive is disposed directly on a surface of the textile layer.

26. A method of forming an interior panel of a vehicle, comprising:
adhering, to a first surface of a panel preform, a textile laminate comprising a barrier layer, a textile layer laminated to one surface of the barrier layer, and an adhesive on an opposite surface of the barrier layer, the adhesive having a tack temperature of less than about 160° F. (71° C.) and the laminate having a sufficiently high melt bond strength to enable the laminate to remain adhered to a substrate to which the laminate had been bonded when the substrate is heated to a temperature of 100F or higher during subsequent processing;
placing the panel preform and textile laminate in a mold; and
applying a molding material to a second surface of the panel preform to form a finished interior panel.

27. A method of forming an interior panel of a vehicle, comprising:
adhering, to a first surface of a panel preform, a textile laminate comprising a barrier layer, a textile layer laminated to one surface of the barrier layer, and an adhesive on an opposite surface of the barrier layer, the adhesive comprising a blocked-isocyanate polyurethane;
placing the panel preform and textile laminate in a mold; and
applying a molding material to a second surface of the panel preform to form a finished interior panel.

28. A method of forming an interior panel of a vehicle, comprising:
adhering, to a first surface of a panel preform, a textile laminate comprising a barrier layer comprising an olefinic polymer and having a surface polarity of at least 36 dynes, a textile layer laminated to one surface of the barrier layer, and an adhesive on an opposite surface of the barrier layer;
placing the panel preform and textile laminate in a mold; and
applying a molding material to a second surface of the panel preform to form a finished interior panel.

29. The method of claim 26, 27 or 28 wherein the adhering step comprises applying the laminate to the panel preform while the panel preform is still above ambient temperature as a result of molding.

30. The method of claim 26, 27 or 28 wherein the adhering step comprises thermoforming.

31. The method of claim 26, 27 or 28 wherein the applying step includes heating to a temperature of at least 150° F. (66° C.).

32. A method of forming a textile laminate comprising:
laminating a continuous film of urethane adhesive to a barrier layer to form a composite; and
laminating the composite to a textile layer.

33. The method of claim 32 further comprising applying a discontinuous adhesive layer to the textile layer.

34. The method of claim 33 wherein the discontinuous adhesive layer is applied to the textile layer prior to laminating the composite to the textile layer.

35. The method of claim 33 wherein the discontinuous adhesive layer is applied to a surface of the textile layer opposite the surface to which the composite is laminated.

36. The method of claim 32 further comprising forming the continuous film of urethane adhesive by casting an adhesive solution on a release film.

37. A method of forming an interior portion of a vehicle, comprising:
adhering, to a surface of a substrate, a textile laminate comprising a textile layer and an adhesive, the adhesive having a tack temperature of less than about 160° F. (71° C.) and the laminate having a sufficiently high melt bond strength to enable the laminate to remain adhered to a substrate to which the laminate had been bonded when the substrate is heated to a temperature of 100F or higher during subsequent processing.

38. A method of forming an interior portion of a vehicle, comprising:
adhering, to a surface of a substrate, a textile laminate comprising a textile layer and an adhesive, the adhesive comprising a blocked-isocyanate polyurethane.

39. A method of forming an interior portion of a vehicle, comprising:
adhering, to a substrate, a textile laminate comprising a barrier layer comprising an olefinic polymer and having a surface polarity of at least 36 dynes, a textile layer laminated to one surface of the barrier layer, and an adhesive on an opposite surface of the barrier layer.

40. The method of claim 37, 38 or 39 wherein the substrate comprises a headliner shell and the interior portion of the vehicle comprises the headliner.

41. The method of claim 40 wherein the textile laminate further comprises a foam layer interposed between the textile layer and the adhesive.

42. The method of claim 37, 38 or 39 wherein the substrate comprises a panel preform for a door.
